(19) United States
(12) Patent Application Publication
(10) Pub. No.: US 2026/0100008 A1
(43) Pub. Date: Apr. 9, 2026

(54) METHOD FOR MIXED REALITY-BASED SPATIAL CURVE DRAWING AND GEOMETRIC ELEMENT GENERATION, AND INTERACTION

(71) Applicant: Zhejiang University, Hangzhou (CN)

(72) Inventors: Liangjing YANG, Hangzhou (CN); Tengyue WANG, Hangzhou (CN); Qingyan LI, Hangzhou (CN); Yunze SHI, Hangzhou (CN)

(73) Assignee: Zhejiang University, Hangzhou (CN)

(21) Appl. No.: 19/340,855

(22) Filed: Sep. 25, 2025

(30) Foreign Application Priority Data
Mar. 3, 2025 (CN) 202510240639.5

(51) Int. Cl. G06T 19/00; G06F 3/01; G06F 3/04815; G06F 3/0482; G06F 3/0488; G06T 19/20; G06V 40/20

(52) U.S. Cl. CPC G06T 19/006; G06F 3/011; G06F 3/04815; G06F 3/0482; G06F 3/0488; G06T 19/20; G06T 2210/21; G06T 2219/2004; G06T 2219/2016; G06V 40/20

(57) ABSTRACT

An interactive mixed reality-based spatial curve drawing and geometric element generation method is disclosed, including steps S1, through a spatial curve drawing module, detecting the hand posture of a user to complete the drawing of a spatial curve; S2, after completing the drawing of the spatial curve, using a geometric element fitting module to complete a geometric element fitting, including the position, orientation, and scale; S3, after completing the geometric element fitting, implementing the geometric element rendering, interaction and parameter adjustment through a geometric element generation and interaction module. The invention provides a method for mixed reality-based spatial curve drawing and geometric element generation, and interaction. Users can use gesture control to draw and generate geometric elements in virtual space, and adjust the geometric parameters of the generated geometric elements online in real time, which significantly improves the interactive experience and operation accuracy.

### TECHNICAL FIELD

The present disclosure relates to immersive human-computer interaction technology, and more specifically, to a method for mixed reality-based spatial curve drawing and geometric element generation, and interaction.

### BACKGROUND

Mixed reality (MR), a blend of virtual reality (VR) and augmented reality (AR), seamlessly fuses virtual objects with the real-world environment, allowing users to engage with virtual elements in real time, thereby achieving a more realistic and interactive experience. As applications of mixed reality continue to expand across various fields, there is a growing demand for intuitive and efficient methods that enable the real-time generation of, and interaction with, geometric elements within immersive virtual environments.

Geometric elements form the foundational building units of virtual objects. In MR environments, the ability to generate customized geometric elements on demand has broad applications, including spatial annotation, boundary visualization, layout design, and rapid prototyping. However, traditional geometric element generation methods primarily rely on predefined 3D models or static geometric primitives, which are often selected from graphical menus. These methods typically require tedious interface navigation and offline processing, making them inefficient and inadequate for dynamic and highly interactive scenarios. For example, in an MR environment, users need to generate corresponding geometric elements based on real-time interactions, and subsequently adjust their position, orientation, and scale. This requires the system not only to seamlessly integrate interactive interfaces and respond quickly to user input, but also to have the ability to process various adjustments in real time.

Compared to traditional methods using predefined models, geometric element generation based on spatial curve drawing can naturally and intuitively simulate the real-world drawing and construction process, thus significantly improving the user experience and creation efficiency.

Currently, mixed reality technology is mainly limited to the visual display of virtual objects, and has not yet realized the real-time generation and dynamic adjustment of virtual objects. The existing technology lacks effective solutions to generate geometric elements based on a user's real-time interaction in an MR environment, which fails to meet the practical needs for instantaneous creation and adjustment, and greatly limits the flexibility and efficiency of creation. This technological gap restricts the application and development of MR technology in more complex and dynamic scenarios. Therefore, it is urgent to develop an innovative technical solution that enables users to realize real-time rendering, generation, and interaction of geometric objects in an MR environment through natural and intuitive gesture operations, so as to satisfy the demand for efficient and flexible creation tools.

### SUMMARY

The present disclosure provides a method for mixed reality-based spatial curve drawing and geometric element generation, and interaction. It aims to solve the limitations introduced in the above background.

In order to achieve this, the invention provides a method for mixed reality-based spatial curve drawing and geometric element generation, and interaction, including the following steps:
S1, through a spatial curve drawing module, detecting user's hand posture to complete a drawing of a spatial curve:
S2, after completing the drawing of the spatial curve, performing geometric element fitting using a geometric element fitting module, including the position, orientation, scale of the geometric element, and related geometric parameters:
S3, rendering, interacting with, and adjusting parameters of the geometric element through a geometric element generation and interaction module.

In some embodiments, the spatial curve drawing module in S1 includes:
finger joint recognition, using images captured by an MR head-mounted display (HMD), to detect poses of finger joints in real-time, including wrist, palm, fingertips, interphalangeal joints, metacarpophalangeal joints, and metacarpal joints:
a customized function menu, triggered by hand gestures, specifically, when the user's left hand is outstretched and the palm is facing the eye, the function menu is summoned: otherwise, the function menu is automatically dismissed.

In some embodiments, the function menu implements various functions:
A, drawing function: the user clicks a drawing function button in the function menu, and a virtual green sphere appears at a right index fingertip, indicating entry into drawing state. The green sphere continuously tracks a position of the right index finger, and the system continuously tracks the position of the right index finger and a thumb fingertip, and calculates a Euclidean distance between the two positions, the formula is as follows:

$$ρ = \sqrt{{( {x}_{2} - {x}_{1} )}^{2} + {( {y}_{2} - {y}_{1} )}^{2} + {( {z}_{2} - {z}_{1} )}^{2}}$$

where (x₁, y₁, z₁) is a coordinate of the right thumb fingertip, (x₂, y₂, z₂) is a coordinate of the right index fingertip, by judging whether the Euclidean distance is less than a certain threshold, if so, it denotes that a curve is starting to be drawn, the system visualizes a motion trajectory of the right index fingertip in real-time into a three-dimensional spatial curve, specifically: a current position of the right index fingertip is added as a new point to a LineRenderer component of Unity3D, and the fingertip position continues to be tracked, when a distance between the fingertip position and a previous point exceeds a predetermined threshold (5 mm), the system collects the fingertip position again as a new point to add to the LineRenderer component: when the two fingers are outstretched, the system ends the drawing of the current curve, the user can draw a new curve by pinching the two fingers again, and can also end the drawing state by clicking the drawing function button again:
B, erasing function: the user clicks an erasing function button, and a virtual red sphere appears at the right index fingertip, indicating that the erasing state is entered, the red sphere continues to track the position of the right index finger, and the system continues to track the position of the right index finger and the thumb fingertip, and calculates the Euclidean distance between the two positions, according to the Euclidean distance judgment, when the two fingers are pinched and the line segment curve drawn by the distance is less than the predetermined threshold (2 cm), the system destroys the corresponding LineRenderer component to erase the line, and the erasing function button is clicked again to end the erasing state: in addition, the erasing function is also applicable to the generated geometric elements, and the operation principle is the same as erasing lines:
C, locking function: after the user clicks the locking function button, the system enters a locking state, at this time, the other function buttons are hidden, and the interaction component of the completed drawn curve and the generated geometric elements is dismissed, the user cannot select or operate the object through the gesture, after clicking the locking function button again, the system ends the locking state and restores a reality and interaction function of all function buttons and gesture interaction components, this function can avoid misoperation.

There is a mutually exclusive relationship between the three functions, when the user clicks a function button to activate the corresponding state, the system will automatically end other functional states to ensure that the functional modules do not interfere with each other and improve the fluency of the user's operation and the response efficiency of the system. For example, when the user clicks the erasing function button in the drawing function state, the system will automatically end the drawing function state and enter the erasing function state, and vice versa.

The geometric element fitting module in S2 supports the drawing, fitting, generation, and interaction of 11 types of geometric elements, including a line segment class, a bounded plane class, a volume class, and a parametric surface class, among them, the line segment class includes a straight line segment and a curve segment: the bounded plane class includes a circular plane, a triangular plane, and a quadrilateral plane: the volume class includes an ellipsoid, a cuboid, and a cylinder: the parametric surface class comprises a funnel, a bowl, and a torus, including:
A, basic feature drawing, when generating a specific geometric element, the user draws a basic feature of the geometric element to complete the drawing of the curve, for example, if the user wants to generate a cuboid, only four edges of two opposite surfaces need to be drawn respectively: if the user wants to generate a cylinder, only two relative circles need to be drawn;
B, fitting function activation: in a non-rendering state, the user activates the fitting function through gestures, according to the Euclidean distance between the specified joints, when the thumb tip and the index finger tip of the user's left hand are pinched, a coroutine is started to monitor the position of the thumb tip and the index finger tip of the left hand, at this time, when the system detects that the two fingers stretch in a short time interval (0.2 seconds), the fitting function is activated; otherwise, the association is dismissed:
C, data preparation: after completing an activation gesture of the fitting function, the system reads all the points in the drawn curve and stores these points in the Vector type of MathNet, after a point set is saved, the system will clear all the drawn curves:
D, for different geometric elements, different fitting algorithms are used for processing.

In some embodiments, for different geometric elements, different fitting algorithms are used for processing, including the following types:
a, line segment: by constructing a covariance matrix and performing eigenvalue decomposition, a principal direction of the line is determined, then, the projection of all points in this direction is calculated, and the starting point, end point, and direction of the line segment are determined by identifying the two far projection points:
b, curve segment: first, a uniformly distributed B-spline knot vector is generated, and then the De Boor algorithm is used to uniformly sample the B-spline curve to generate a dense curve point set: by calculating a cumulative length between sampling points and performing linear interpolation according to the preset interval distance, a smooth and equidistant fitting point set is finally obtained;
c, plane with boundary: a normal vector and centroid of the plane are calculated by principal component analysis (PCA) method, and a three-dimensional point set is projected onto a fitting plane to obtain a two-dimensional point set, a convex hull of the projected point set is calculated by QuickHull algorithm to determine an outer boundary, and a polygon with the largest area is identified in a convex hull point set (using a dodecagon approximate circle) as a final fitting result, an output of the algorithm includes the vertex coordinates of the polygon and rotation information thereof:
d, ellipsoid: a linear equation is constructed, and a center coordinate and a radius parameter are solved by the least squares method:
e, cuboid: based on a connection distance threshold between adjacent points (4 cm), an input point set is divided into two clusters, and a depth direction is determined by calculating the centroids of the two set clusters. Four vertices are obtained by rectangular fitting of the larger point set cluster, and the complete eight vertices are generated by combining the depth information.
f, cylinder: the clustering method is used to partition, and the center position, axial direction, and height are determined by calculating the centroids of the two set clusters, a circle fitting based on the least squares method is performed on the larger point set to obtain the radius of the cylinder.
g, funnel and bowl: firstly, a low point in a point set is identified as a bottom vertex, and the point most distant from the bottom is selected as a top vertex, and the vertices are substituted into a two-dimensional curve equation, where it is a funnel:

$$y = γ ln ( \frac{x}{α} - β ) ;$$

when it is a bowl: y=αx^{β}, corresponding surface parameters are obtained: the two-dimensional curve is rotated to obtain a three-dimensional surface, where it is a funnel:

$${x}^{2} + {z}^{2} - α {e}^{\frac{y}{γ}} + α β = 0 ;$$

when it is a bowl: α(x²+z²)^{γ/2}−y=0; among them, x, y and Z denote coordinates of points on the curve or surface in three-dimensional space respectively, α denotes an offset ratio of x, which is used to control the scaling of the surface, β denotes the offset of the curve, which is used to control a starting point of the curve and a position of the surface, γ denotes a shape parameter of the curve, which is used to control a bending degree of the curve, and α denotes a scaling parameter of the curve, which is used to control scaling of the surface:
h, torus: a center, a radius, and a normal vector of the two circles are obtained by fitting point sets of the large circle and the small circle with the least squares method, and a three-dimensional surface equation of the torus is obtained: (\sqrt{x²+z²}−R)²+y²−r²=0, where R is a radius of the large circle and r is a radius of the small circle.

In some embodiments, the geometric element generation and interaction module in S3 includes the following functions:
geometric element rendering: reading a fitting point set, using a custom method to generate a mesh of the geometric elements:
geometric element interaction: based on the generated mesh, generating a collider for the geometric elements, and adding an ObjectManipulator component in MRTK3 to realize a natural interaction between the user and the geometric elements, the user directly grabs, moves, rotates and scales the geometric elements through gestures, at the same time, the ConstraintManager component in MRTK3 is used to customize a limit management for an interaction behavior of the geometric elements, for example, the geometric elements are only allowed to move and rotate in a specified direction, when the user's hand touches the geometric elements, the boundary of the geometric elements will light up, showing the boundary of the current geometric elements; when the hand leaves, the border will gradually disappear:
orientation indication: each geometric element is equipped with an arrow or coordinate system to describe an orientation, when the user's hand touches the geometric elements, the arrow or coordinate system appears, when the hand is not touching, the arrow or coordinate system will disappear:
after each movement or rotation of the geometric elements, the system will start a coroutine to automatically determine and adjust an alignment of a y-axis of the geometric element with a world coordinate system:
customized adjustment is performed for the geometric parameters.

In some embodiments, the specific steps for geometric element rendering are as follows:
vertex generation: by calculating x and z coordinates of the geometric elements at different heights (y values) in a local coordinate system, multiple sets of vertices at different heights are obtained;
surface construction: a triangular surface is formed between vertices of adjacent heights to describe Mesh, and MeshFilter and MeshRenderer components are added to achieve complete rendering and visualization of the geometric elements.

In some embodiments, after each movement or rotation of the geometric elements, the system will start a coroutine to automatically determine and adjust the alignment of the y-axis of the geometric elements with the world coordinate system, the specific steps are as follows:
angle calculation: an angle between the y-axis of the geometric element and the three-axis of the world coordinate system is calculated:
alignment determination: when the angle is less than a predetermined threshold (5°), the system aligns the y-axis of the geometric element to the corresponding axis of the world coordinate system by smooth rotation.

In some embodiments, customized adjustment of geometric parameters, including:
A, triangular plane and quadrilateral plane
interactive node generation: an interactive sphere is generated at a vertex position of the geometric element:
gesture interaction: when the user's hand is in contact with the geometric elements, the vertex sphere is visualized and the interaction component is activated, the user realizes the dynamic adjustment of the vertex position by grasping the sphere and moving it on the triangle or quadrilateral plane:
real-time fitting: when moving the vertex sphere, the geometric element generation and interaction module will activate the corresponding geometric element fitting algorithm, calculate, update, and render the mesh of the geometric element in real-time:
B, ellipsoid, cuboid, and cylinder
orientation coordinate system: for volume geometric elements, the geometric element generation and interaction module configures a coordinate axis used to describe the local coordinate system:
independent axial scaling: the user realizes an independent scaling operation of the geometric elements on the xyz axes in the local coordinate system by grasping and moving the coordinate axis of the local coordinate system (i.e., the orientation); this independent axial scaling method enables users to accurately adjust the scale of the geometric elements in all directions.
C, parametric surface
for different parametric surfaces, the geometric element generation and interaction module will generate corresponding interactive elements;
parameter dynamic adjustment: the user grabs and moves the interactive elements through gestures, and the geometric element generation and interaction module will automatically update the corresponding surface parameters to realize the dynamic adjustment of the parametric surface, at the same time, in the process of parameter adjustment, the system will recalculate the mesh data of the geometric elements in real time and render the updated surface in real time.

Therefore, the invention adopts the above-mentioned method for mixed reality-based spatial curve drawing and geometric element generation, and interaction, which has the following beneficial effects:
(1) by setting the spatial curve drawing module, users are allowed to freely use their fingers to draw and erase curves in a three-dimensional virtual space based on hand tracking and gesture recognition:
(2) by calculating the distance between the current finger joint position and the previous storage point, whether to store the new point is determined, it not only significantly improves the efficiency of the algorithm, reduces the computational burden, but also provides better input data for the subsequent module processing:
(3) in the geometric element generation and interaction module, the geometric element fitting requirements in specific scenarios are realized through the combination of different mathematical methods:
(4) in the geometric element generation and interaction module, by using the basic components of the MRTK3 open source framework (including ObjectManipulator, ConstraintManager, and BoundsControl), and functional expansion and optimization, a richer interactive experience is fulfilled.

The following is a further detailed description of the technical scheme of the invention through drawings and an implementation example.

### BRIEF DESCRIPTION OF THE DRAWINGS

FIG. 1 is a flow chart of the method for mixed reality-based spatial curve drawing and geometric element generation, and interaction.

FIG. 2 is a schematic diagram of the customized function menu of the embodiment of the invention.

FIG. 3 is a schematic diagram of the principle of the drawing function of the embodiment of the invention.

FIG. 4 is a schematic diagram of the geometric element menu selection of the embodiment of the invention:

FIG. 5 is a schematic diagram of the basic characteristics of the embodiment of the invention:

FIG. 6 is an activation diagram of the fitting function of the embodiment of the invention, where (a) is before fitting, (b) is the activation fitting function, and the geometric elements are generated:

FIG. 7 is a schematic diagram of the corresponding interactive elements generated by the parametric surface of the embodiment of the invention.

### DETAILED DESCRIPTION OF THE EMBODIMENTS

The following detailed description of the embodiment of the invention provided in the accompanying diagram is not intended to limit the scope of the invention requiring protection, but merely indicates the selected embodiment of the invention. Based on the embodiments in this invention, all other embodiments obtained by ordinary technicians in this field without making creative labor belong to the scope of protection of this invention.

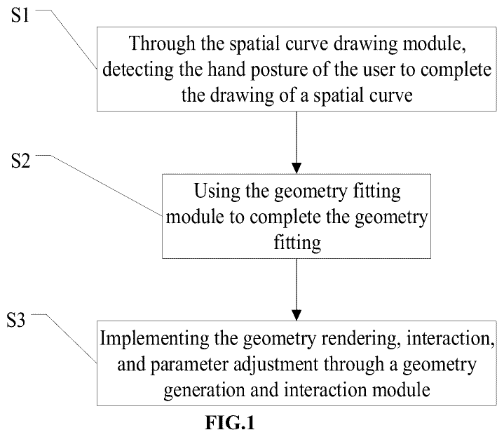

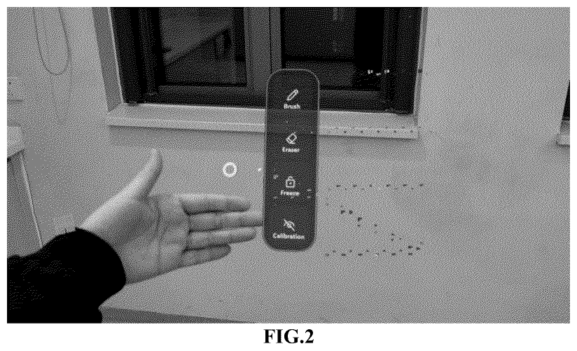

Please refer to FIG. 1, the method of spatial curve drawing and geometric element generation and interaction based on mixed reality, including the following steps:
S1, through the spatial curve drawing module, the hand posture of the user is detected to complete the drawing of the spatial curve: the spatial curve drawing module includes:
finger joint recognition, using the images captured by MR head mounted display, to detect poses of finger joints in real-time, including wrist, palm, fingertip, interphalangeal joint, metacarpophalangeal joint, and metacarpal joint;
customized function menu, as shown in FIG. 2, the customized function menu is summoned and dismissed through gesture recognition, when the user's left hand is outstretched and the palm is facing the eye, the function menu is summoned; otherwise, the function menu is automatically dismissed, the function menu includes a drawing function, an erasing function and a locking function, and the function menu is used to assist users to switch freely between functions.

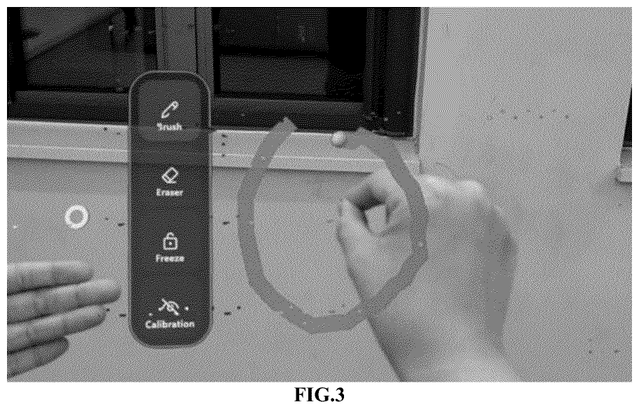

The function menu provides a variety of functional modules, which aim to realize the drawing, erasing, and locking operations of the geometric elements in the mixed reality environment through gesture control, specifically:
A, drawing function: the user clicks the drawing function button in the function menu, and a virtual green sphere appears at the fingertip of a right index finger, indicating that the drawing state is entered, the green sphere continuously tracks the position of the right index finger, and the system continuously tracks the position of the right index finger and the thumb fingertip, and calculates the Euclidean distance between the two positions, the formula is as follows:

$$ρ = \sqrt{{( {x}_{2} - {x}_{1} )}^{2} + {( {y}_{2} - {y}_{1} )}^{2} + {( {z}_{2} - {z}_{1} )}^{2}}$$

where (x₁, y₁, z₁) is a coordinate of the right thumb fingertip, (x₂, y₂, z₂) is a coordinate of the right index fingertip, by judging whether the Euclidean distance is less than a certain threshold, if so, it denotes that the curve is starting to be drawn, the system visualizes the motion trajectory of the right index fingertip in real time into a three-dimensional spatial curve, as shown in FIG. 3, specifically: a current position of the right index fingertip is added as a new point to a LineRenderer component of Unity3D, and the fingertip position continues to be tracked, when a distance between the fingertip position and a previous point exceeds a predetermined threshold (5 mm), the system collects the fingertip position again as a new point to add to the LineRenderer component: when the two fingers are outstretched, the system ends the drawing of the current curve, the user can draw a new curve by pinching the two fingers again, and can also end the drawing state by clicking the drawing function button again:
B, erasing function: the user clicks an erasing function button, and a virtual red sphere appears at the right index fingertip, indicating that the erasing state is entered, the red sphere continues to track the position of the right index finger, and the system continues to track the position of the right index finger and the thumb fingertip, and calculates the Euclidean distance between the two positions, according to the Euclidean distance judgment, when the two fingers are pinched and the line segment curve drawn by the distance is less than the predetermined threshold (2 cm), the system destroys the corresponding LineRenderer component to erase the line, and the erasing function button is clicked again to end the erasing state: in addition, the erasing function is also applicable to the generated geometric elements, and the operation principle is the same as erasing lines:
C, locking function: after the user clicks the locking function button, the system enters a locking state, at this time, the other function buttons are hidden, and the interaction component of the completed drawn curve and the generated geometric elements are dismissed, the user cannot select or operate the object through the gesture, after clicking the locking function button again, the system ends the locking state and restores a reality and interaction function of all function buttons and gesture interaction components, this function can avoid misoperation.

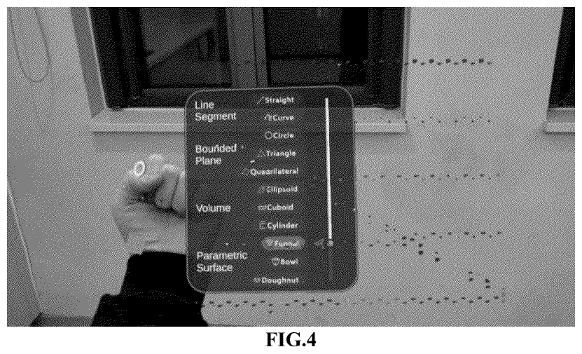

There is a mutually exclusive relationship between the three functions, when the user clicks a function button to activate the corresponding state, the system will automatically end other functional states to ensure that the functional modules do not interfere with each other and improve the fluency of the user's operation and the response efficiency of the system. For example, when the user clicks the erasing function button in the drawing function state, the system will automatically end the drawing function state and enter the erasing function state, and vice versa.
S2, after completing the drawing of the spatial curve, a geometric element fitting module is used to complete a geometric element fitting, including the position, orientation, and scale, as well as related geometric parameters of a geometric element:
the geometric element fitting module supports the drawing, fitting, generation, and interaction of 11 types of geometric elements, including a line segment class, a bounded plane class, a volume class, and a parametric surface class, among them, the line segment class includes a straight line segment and a curve segment: the bounded plane class includes a circular plane, a triangular plane, and a quadrilateral plane: the volume class includes an ellipsoid, a cuboid, and a cylinder: the parametric surface class comprises funnel, bowl, and torus, including:
geometric element selection menu: as shown in FIG. 4, the user selects the geometric elements to be generated by clicking the button or dragging the slider, and the name of the selected geometric elements will be highlighted: the menu is summoned and dismissed based on gesture recognition. When the system recognizes that the user's left hand holds a five-finger first and the palm is facing the eye, the function menu is summoned, otherwise, the function menu is automatically dismissed:

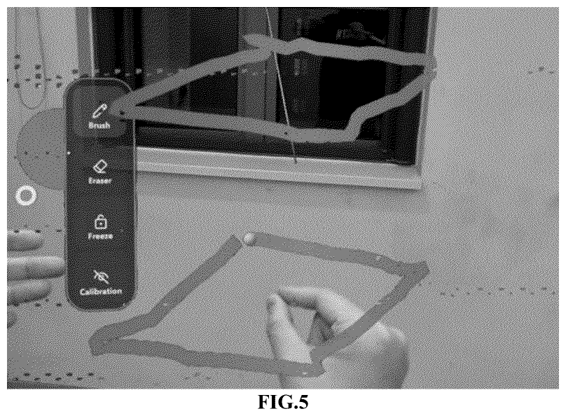

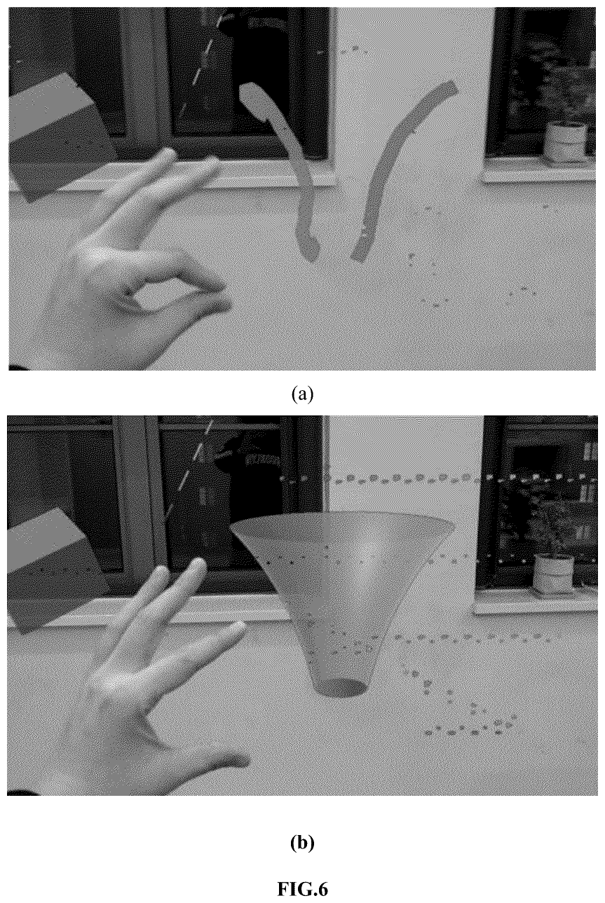

The parameters of the fitted geometric elements include:
(1) basic feature drawing
when generating a specific geometric element, the user draws a basic feature of the geometric elements to complete the drawing of the curve, for example, if the user wants to generate a cuboid, only four edges of two opposite surfaces need to be drawn respectively: as shown in FIG. 5, if the user wants to generate a cylinder, only two relative circles need to be drawn:
(2) fitting function activation
in a non-rendering state, the user activates the fitting function through gestures, according to the Euclidean distance between the specified joints, when the thumb tip and the index finger tip of the user's left hand are pinched, a coroutine is started to monitor the position of the thumb tip and the index finger tip of the left hand, at this time, when the system detects that the two fingers stretch in a short time interval (0.2 seconds), the fitting function is activated; otherwise, the association is dismissed; as shown in FIG. 6.
(3) data preparation
after completing an activation gesture of the fitting function, the system reads all the points in the drawn curve and stores these points in the Vector<double> type of MathNet, after a point set is saved, the system will clear all the drawn curves:
(4) geometric element fitting algorithm
D, for different geometric elements, different fitting algorithms are used for processing, specifically, it includes the following types:
a, line segment: by constructing a covariance matrix and performing eigenvalue decomposition, a principal direction of the line is determined, then, the projection of all points in this direction is calculated, and the starting point, end point, and direction of the line segment are determined by identifying the two far projection points:
b, curve segment: first, a uniformly distributed B-spline knot vector is generated, and then the De Boor algorithm is used to uniformly sample the B-spline curve to generate a dense curve point set: by calculating a cumulative length between sampling points and performing linear interpolation according to the preset interval distance, a smooth and equidistant fitting point set is finally obtained:
c, plane with boundary: a normal vector and centroid of the plane are calculated by principal component analysis (PCA) method, and a three-dimensional point set is projected onto a fitting plane to obtain a two-dimensional point set, a convex hull of the projected point set is calculated by QuickHull algorithm to determine an outer boundary, and a polygon with the largest area is identified in a convex hull point set (using a dodecagon approximate circle) as a final fitting result, an output of the algorithm includes the vertex coordinates of the polygon and rotation information thereof:
d, ellipsoid: a linear equation is constructed, and a center coordinate and a radius parameter are solved by the least squares method:
e, cuboid: based on a connection distance threshold between adjacent points (4 cm), an input point set is divided into two clusters, a depth direction is determined by calculating the centroids of the two set clusters, four vertices are obtained by rectangular fitting of the larger point set cluster, and the complete eight vertices are generated by combining the depth information:
f, cylinder: the clustering method is used to partition, and the center position, axial direction, and height are determined by calculating the centroids of the two set clusters, a circle fitting based on the least squares method is performed on the larger point set to obtain the radius of the cylinder:
g, funnel and bowl: firstly, a low point in a point set is identified as a bottom vertex, and the point most distant from the bottom is selected as a top vertex, and the vertices are substituted into a two-dimensional curve equation, where it is a funnel:

$$y = γ ln ( \frac{x}{α} - β ) ;$$

when it is a bowl: γ=αx^{β}, corresponding surface parameters are obtained: the two-dimensional curve is rotated to obtain a three-dimensional surface, where it is a funnel:

$${x}^{2} + {z}^{2} - α {e}^{\frac{y}{γ}} + α β = 0 ;$$

when it is a bowl: α(x²+z²)^{γ/2}−y=0; among them, x, y and Z denote coordinates of points on the curve or surface in three-dimensional space respectively, α denotes an offset ratio of x, which is used to control the scaling of the surface, β denotes the offset of the curve, which is used to control a starting point of the curve and a position of the surface, γ denotes a shape parameter of the curve, which is used to control a bending degree of the curve, and a denotes a scaling parameter of the curve, which is used to control a scaling of the surface:

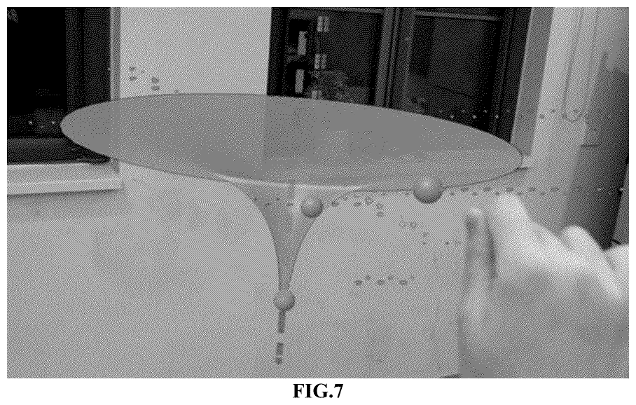

h, torus: a center, a radius, and a normal vector of the two circles are obtained by fitting point sets of the large circle and the small circle with the least squares method, and a three-dimensional surface equation of the torus is obtained: (\sqrt{x²+z²}−R)²+y²−r²=0, where R is a radius of the large circle and r is a radius of the small circle.
S3, after completing the geometric element fitting, implementing a geometric element rendering, interaction, and parameter adjustment through a geometric element generation and interaction module, including the following functions:
1, geometric element rendering: reading a fitting point set, using a custom method to generate a mesh of the geometric elements: specifically, including the following steps:
vertex generation: by calculating x and z coordinates of the geometric elements at different heights (y values) in a local coordinate system, multiple sets of vertices at different heights are obtained:
surface construction: a triangular surface is formed between vertices of adjacent heights to describe Mesh, and MeshFilter and MeshRenderer components are added to achieve complete rendering and visualization of the geometric elements.
2. geometric element interaction: based on the generated mesh, generating a collider for the geometric elements, and adding an ObjectManipulator component in MRTK3 to realize a natural interaction between the user and the geometric elements, the user directly grabs, moves, rotates, and scales the geometric elements through gestures, at the same time, the ConstraintManager component in MRTK3 is used to customize a limit management for an interaction behavior of the geometric elements, for example, the geometric elements are only allowed to move and rotate in a specified direction, The BoundsControl component in MRTK3 is used, when the user's hand touches the geometric elements, the boundary of the geometric elements will light up, showing the boundary of the current geometric elements: when the hand leaves, the border will gradually disappear:
3, orientation indication: each geometric element is equipped with an arrow or coordinate system to describe an orientation, when the user's hand touches the geometric elements, the arrow or coordinate system appears, when the hand is not touching, the arrow or coordinate system will disappear:
4, after each movement or rotation of the geometric elements, the system will start a coroutine to automatically determine and adjust the alignment of the y-axis of the geometric elements with a world coordinate system: the specific steps are as follows:
angle calculation: calculate the angle between the y-axis of the geometric elements and the three-axis of the world coordinate system:
alignment determination: when the angle is less than the predetermined threshold (5°), the system aligns the y-axis of the geometric elements to the corresponding axis of the world coordinate system by smooth rotation.
5, customize the geometric element parameters: although the ObjectManipulator component provides the basic geometric element scaling function, there are limitations in some cases. For example, when scaling a triangle plane, the ObjectManipulator component can only scale in equal proportions, i.e., by changing the length of three edges, but not by changing the ratio between the three edges. The geometric element generation and interaction module is optimized for this problem, including:
A, triangular plane and quadrilateral plane
interactive node generation: an interactive sphere is generated at a vertex position of the geometric element:
gesture interaction: when the user's hand is in contact with the geometric elements, the vertex sphere is visualized and the interaction component is activated, the user realizes the dynamic adjustment of the vertex position by grasping the sphere and moving it on the triangle or quadrilateral plane:
real-time fitting: when moving the vertex sphere, the geometric element generation and interaction module will activate the corresponding geometric element fitting algorithm, calculate, update, and render the mesh of the geometric elements in real-time:
B, ellipsoid, cuboid, and cylinder
orientation coordinate system: for volume geometric elements, the geometric element generation and interaction module configures a coordinate axis used to describe the local coordinate system:
independent axial scaling: the user realizes an independent scaling operation of the geometric elements on the xyz axes in the local coordinate system by grasping and moving the coordinate axis of the local coordinate system (i.e., the orientation); this independent axial scaling method enables users to accurately adjust the scale of the geometric elements in all directions.
C, parametric surface
for different parametric surfaces, the geometric element generation and interaction module will generate corresponding interactive elements: for example, for the funnel surface, three spheres and an asymptote will be generated, as shown in FIG. 7.
parameter dynamic adjustment: the user grabs and moves the interactive elements through gestures, and the geometric element generation and interaction module will automatically update the corresponding surface parameters to realize the dynamic adjustment of the parametric surface, at the same time, in the process of parameter adjustment, the system will recalculate the mesh data of the geometric elements in real time and render the updated surface in real time.
Therefore, the invention adopts the above-mentioned method for mixed reality-based spatial curve drawing and geometric element generation, and interaction. Users can use gesture control to draw and generate the geometric elements in virtual space, and adjust the geometric parameters of the generated geometric elements online in real-time, which significantly improves the interactive experience and operation accuracy.

Finally, it should be explained that the above embodiments are only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A method for mixed reality-based spatial curve drawing and geometric element generation and interaction, comprising the following steps:
S1, through a spatial curve drawing module, detecting user's hand posture to generate a drawing of a spatial curve;
S2, after generating the drawing of the spatial curve, using a geometric element fitting module to generate a geometric element fitting, including the position, orientation, and scale, as well as related geometric parameter of a geometric element;
S3, after generating the geometric element fitting, implementing a geometric element rendering, interaction, and adjusting parameters through a geometric element generation and interaction module;
wherein the geometric element generation and interaction module comprises the following functions:
geometric element rendering, wherein the geometric element rendering comprises reading a fitting point set, using a custom method to generate a mesh of the geometric element;
geometric element interaction, wherein geometric element interaction comprises generating a collider for the geometric elements based on the generated mesh, and adding an ObjectManipulator component in MRTK3 to realize a natural interaction between the user and the geometric elements, wherein the user directly grabs, moves, rotates, and scales the geometric elements through gestures, wherein, at the same time, a ConstraintManager component in MRTK3 is used to customize a limit management for an interaction behavior of the geometric elements, wherein, when the user's hand touches the geometric elements, a boundary of the geometric elements will light up, showing the boundary of the current geometric elements; and when the hand leaves, a border will gradually disappear;
orientation indication, wherein each geometric element is equipped with an arrow or coordinate system to describe an orientation, wherein when the user's hand touches the geometric elements, the arrow or coordinate system appears, and when the hand is not touching, the arrow or coordinate system will disappear;
wherein after each movement or rotation of the geometric elements, the system will start a coroutine to automatically determine and adjust the alignment of the y-axis of the geometric elements with a world coordinate system;
wherein customized adjustment is performed for the geometric parameters;
wherein customized adjustment of geometric parameters, specifically comprises:
A) a triangular plane and quadrilateral plane;
interactive node generation comprising generating an interactive sphere at a vertex position of the geometric elements;
gesture interaction, wherein when the user's hand is in contact with the geometric elements, visualizing a vertex sphere and activating an interaction component, wherein the user realizes the dynamic adjustment of the vertex position by grasping the sphere and moving it on the triangle or quadrilateral plane;
real-time fitting, wherein, when moving the vertex sphere, the geometric element generation and interaction module will activate the corresponding geometric element fitting algorithm, calculate, update, and render the mesh of the geometric elements in real-time;
B) ellipsoid, cuboid, and cylinder;
orientation coordinate system, wherein, for volume geometric elements, the geometric element generation and interaction module configures a coordinate axis used to describe the local coordinate system;
independent axial scaling, wherein the user realizes an independent scaling operation of the geometric elements on the xyz axes in the local coordinate system by grasping and moving the coordinate axis of the local coordinate system;
C) parametric surface
wherein for different parametric surfaces, the geometric element generation and interaction module will generate corresponding interactive elements;
parameter dynamic adjustment, wherein the user grabs and moves the interactive elements through gestures, and the geometric element generation and interaction module will automatically update the corresponding surface parameters to realize the dynamic adjustment of the parametric surface, at the same time, in the process of parameter adjustment, the system will recalculate the mesh data of the geometric elements in real time and render the updated surface in real time.

2. The method for mixed reality-based spatial curve drawing and geometric element generation and interaction according to claim 1, wherein the spatial curve drawing module in
S1 comprises:
finger joint recognition using the images captured by MR head mounted display (HMD) to detect poses of finger joints in real-time;
customized function menu wherein the customized function menu is summoned and dismissed through gesture recognition, wherein, when the user's left hand is outstretched and the palm is facing the eye, the function menu is summoned; otherwise, the function menu is automatically dismissed, wherein the function menu includes a drawing function, an erasing function and a locking function.

3. The method for mixed reality-based spatial curve drawing and geometric element generation and interaction according to claim 2, wherein the functional menu implements various functions through gesture control, specifically:
A) a drawing function, wherein the user clicks a drawing function button in the function menu and a virtual green sphere appears at a fingertip of a right index finger, indicating that a drawing state is entered, wherein the green sphere continuously tracks a position of the right index finger, and the system continuously tracks the position of the right index finger and a thumb fingertip, and calculates a Euclidean distance between the two positions, the formula is as follows:
$$ρ = \sqrt{{( {x}_{2} - {x}_{1} )}^{2} + {( {y}_{2} - {y}_{1} )}^{2} + {( {z}_{2} - {z}_{1} )}^{2}}$$
where (x₁, y₁, z₁) is a coordinate of the right thumb fingertip, (x₂, y₂, z₂) is a coordinate of the right index fingertip, wherein, if the Euclidean distance is less than a certain threshold, a curve is starting to be drawn, wherein the system visualizes a motion trajectory of the right index fingertip in real-time into a three-dimensional spatial curve, specifically: a current position of the right index fingertip is added as a new point to a LineRenderer component of Unity3D, and the fingertip position continues to be tracked, wherein, when a distance between the fingertip position and a previous point exceeds a predetermined threshold), the system collects the fingertip position again as a new point to add to the LineRenderer component; wherein, when the two fingers are outstretched, the system ends the drawing of the current curve, the user can draw a new curve by pinching the two fingers again, and can also end the drawing state by clicking the drawing function button again;
B) an erasing function, wherein the user clicks an erasing function button, and a virtual red sphere appears at the right index fingertip, indicating that the erasing state is entered, the red sphere continues to track the position of the right index finger, and the system continues to track the position of the right index finger and the thumb fingertip, and calculates the Euclidean distance between the two positions, wherein according to the Euclidean distance judgment, when the two fingers are pinched and the line segment curve drawn by the distance is less than the predetermined threshold, the system destroys the corresponding LineRenderer component to erase the line, and the erasing function button is clicked again to end the erasing state;
C) a locking function, wherein, after the user clicks the locking function button, the system enters a locking state, at which time the other function buttons are hidden, and the interaction component of the completed drawn curve and the generated geometric element is dismissed, the user cannot select or operate the object through the gesture, after clicking the locking function button again, the system ends the locking state and restores a reality and interaction function of all function buttons and gesture interaction components, this function can avoid misoperation;
wherein there is a mutually exclusive relationship between the three functions, and when the user clicks a function button to activate the corresponding state, the system will automatically end other functional states.

4. The method for mixed reality-based spatial curve drawing and geometric element generation and interaction according to claim 1, wherein the geometric element fitting module in S2 supports the drawing, fitting, generation, and interaction of 11 types of geometric elements, comprising a line segment class, a bounded plane class, a volume class and a parametric surface class, wherein, the line segment class comprises a straight line segment and a curve segment; wherein the bounded plane class comprises a circular plane, a triangular plane, and a quadrilateral plane; wherein the volume class comprises an ellipsoid, a cuboid, and a cylinder; and wherein the parametric surface class comprises funnel, bowl, and torus;
wherein: the user selects the geometric elements to be generated by clicking a button or dragging a slider, and the name of the selected geometric elements will be highlighted; the menu is summoned and dismissed based on gesture recognition; and when the system recognizes that the user's left hand holds a five-finger first and the palm is facing the eye, the function menu is summoned, otherwise, the function menu is automatically dismissed, fitting the geometric parameters.

5. The method for mixed reality-based spatial curve drawing and geometric element generation and interaction according to claim 4, wherein fitting the geometric parameters comprises:
A) basic feature drawing, when generating a specific geometric element, the user draws a basic feature of the geometric element to complete the drawing of the curve;
B) fitting function activation: in a non-rendering state, the user activates the fitting function through gestures, according to the Euclidean distance between the specified joints, wherein, when the thumb tip and the index finger tip of the user's left hand are pinched, a coroutine is started to monitor the position of the thumb tip and the index finger tip of the left hand so that when the system detects that the two fingers stretch in a short time interval, the fitting function is activated; otherwise, the association is dismissed;
C) data preparation: after completing an activation gesture of the fitting function, the system reads all the points in the drawn curve and stores these points in the Vector type of MathNet <double>, after a point set is saved, the system will clear all the drawn curves;
D) for different geometric elements, different fitting algorithms are used for processing.

6. The method for mixed reality-based spatial curve drawing and geometric element generation and interaction according to claim 5, wherein for different geometric elements, different fitting algorithms are used for processing, comprising the following types:
a) line segment, wherein, by constructing a covariance matrix and performing eigenvalue decomposition, a principal direction of the line is determined, then, the projection of all points in this direction is calculated, and the starting point, end point, and direction of the line segment are determined by identifying the two far projection points;
b) curve segment, wherein, first, a uniformly distributed B-spline knot vector is generated, and then the De Boor algorithm is used to uniformly sample the B-spline curve to generate a dense curve point set; by calculating a cumulative length between sampling points and performing linear interpolation according to the preset interval distance, a smooth and equidistant fitting point set is finally obtained;
c) plane with boundary, wherein a normal vector and centroid of the plane are calculated by principal component analysis method, and a three-dimensional point set is projected onto a fitting plane to obtain a two-dimensional point set, a convex hull of the projected point set is calculated by QuickHull algorithm to determine an outer boundary, and a polygon with a largest area is identified in a convex hull point set as a final fitting result, wherein an output of the algorithm comprises the vertex coordinates of the polygon and rotation information thereof;
d) ellipsoid, wherein a linear equation is constructed, and a center coordinate and a radius parameter are solved by a least squares method;
e) cuboid, wherein, based on a connection distance threshold between adjacent points, an input point set is divided into two clusters, a depth direction is determined by calculating the centroids of the two set clusters, four vertices are obtained by rectangular fitting of the larger point set cluster, and complete eight vertices are generated by combining the depth information;
f) cylinder, wherein the clustering method is used to partition, and the center position, axial direction, and height are determined by calculating the centroids of the two set clusters, and wherein a circle fitting based on the least squares method is performed on the larger point set to obtain a radius of the cylinder;
g) funnel and bowl, wherein, firstly, a low point in a point set is identified as a bottom vertex, and the point most distant from the bottom is selected as a top vertex, and the vertices are substituted into a two-dimensional curve equation, wherein, when it is a funnel:
$$y = γ ln ( \frac{x}{α} - β ) ;$$
and when it is a bowl: y=αx^{β}, corresponding surface parameters are obtained; wherein the two-dimensional curve is rotated to obtain a three-dimensional surface, wherein, when it is a funnel;
$${x}^{2} + {z}^{2} - α {e}^{\frac{y}{γ}} + α β = 0 ;$$
and when it is a bowl: α(x²+z²)^{γ/2}−y=0; wherein x, y and Z denote coordinates of points on the curve or surface in three-dimensional space respectively, α denotes an offset ratio of x, which is used to control the scaling of the surface, β denotes the offset of the curve, which is used to control a starting point of the curve and a position of the surface, γ denotes a shape parameter of the curve, which is used to control a bending degree of the curve, and a denotes a scaling parameter of the curve, which is used to control a scaling of the surface;
h) torus, wherein a center, a radius, and a normal vector of the two circles are obtained by fitting point sets of the large circle and the small circle with the least squares method, and a three-dimensional surface equation of the torus is obtained, wherein (\sqrt{x²+z²}−R)²+y²−r²=0, where R is a radius of the large circle and r is a radius of the small circle.

7. The method for mixed reality-based spatial curve drawing and geometric element generation and interaction according to claim 1, wherein the specific steps for geometric element rendering are as follows:
vertex generation, wherein vertex generation comprises calculating x and z coordinates of the geometric elements at different heights in a local coordinate system, and multiple sets of vertices at different heights are obtained;
surface construction, wherein surface construction comprises forming a triangular surface between vertices of adjacent heights to describe Mesh, and MeshFilter and adding MeshRenderer components to achieve complete rendering and visualization of the geometric elements.

8. The method for mixed reality-based spatial curve drawing and geometric element generation and interaction according to claim 1, wherein after each movement or rotation of the geometric elements, the system will start a coroutine to automatically determine and adjust the alignment of the y-axis of the geometric elements with the world coordinate system, the specific steps are as follows:
angle calculation, wherein an angle between the y-axis of the geometric elements and the three-axis of the world coordinate system is calculated;
alignment determination, wherein, when the angle is less than a predetermined threshold, the system aligns the y-axis of the geometric elements to the corresponding axis of the world coordinate system by smooth rotation.
